(19) United States
(12) Patent Application Publication
(10) Pub. No.: US 2009/0205365 A1
(43) Pub. Date: Aug. 20, 2009

(54) METHOD AND APPARATUS FOR LIQUEFYING A NATURAL GAS STREAM

(76) Inventors: Michiel Gijsbert Van Aken, The Hague (NL); Marcus Johannes Antonius Van Dongen, The Hague (NL); Peter Marie Paulus, The Hague (NL); Johan Jan Barend Pek, The Hague (NL); David Bertil Runbalk, The Hague (NL)

Correspondence Address: SHELL OIL COMPANY, P O BOX 2463, HOUSTON, TX, 772522463, US

(21) Appl. No.: 12/373,099

(22) PCT Filed: Jul. 11, 2007
(86) PCT No.: PCT/EP07/57069

§ 371 Date: Jan. 29, 2009

(30) Foreign Application Priority Data
Jul. 13, 2006 (EP) 06117142.7

(51) Int. Cl. F25J 1/02; F17C 7/02; F17C 13/00

(52) U.S. Cl. 62/611; 62/50.1; 62/50.7

(57) ABSTRACT

The present invention provides a method of natural gas, the method at least comprising the steps of: (a) providing a natural gas stream (10) at a first location (2); (b) treating the natural gas stream (10) in the first location (2) thereby obtaining a treated natural gas stream (20), wherein the treated natural gas stream comprises in the range of from 70 to 100 mole % of methane; (c) transporting the treated natural gas stream (20) via a pipeline (4) over a distance of at least 2 km to a second location (3); (d) liquefying the treated natural gas stream (20) at the second location (3) thereby obtaining liquefied hydrocarbon product (50) at atmospheric pressure.

The present invention relates to a method of liquefying a natural gas stream.

Several methods of liquefying a natural gas stream thereby obtaining liquefied natural gas (LNG) are known. It is desirable to liquefy a natural gas stream for a number of reasons. As an example, natural gas can be stored and transported over long distances more readily as a liquid than in gaseous form, because it occupies a smaller volume and does not need to be stored at high pressures.

Usually, the natural gas stream to be liquefied (mainly comprising methane) contains ethane, heavier hydrocarbons and possibly other components that are to be removed to a certain extent before the natural gas is liquefied. To this end, the natural gas stream is treated. One of the treatments may involve the removal of undesired components such as H₂O, CO₂ and H₂S and some of the ethane, propane and higher hydrocarbons such as butane and pentane.

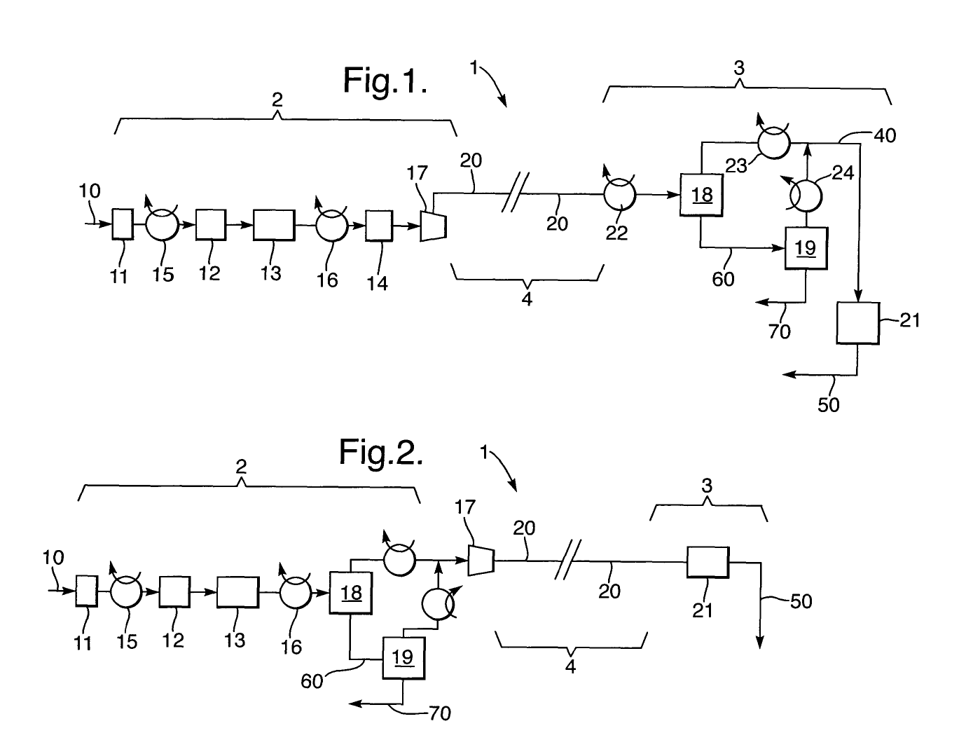

In WO 2006/009646 A2 a method is disclosed for liquefying natural gas. In FIG. 1 a conventional LNG liquefaction plant is shown, wherein the LNG liquefaction plant includes several examples of optional treatment steps such as feed purification steps (liquids removal, hydrogen sulphide removal, carbon dioxide removal, dehydration), product purification steps (helium removal, nitrogen removal) and non-methane product production steps (de-ethanizing, de-propanizing, sulphur recovery). According to WO 2006/009646 A2 the liquefaction and treatment are both performed on a single location.

A problem of the known method is that, if at the place where the natural gas is treated and liquefied no easy access exist for ships or vessels intended for transporting the LNG to remote markets, the LNG has to be transported via a pipeline to a remote port first. This is highly undesirable in view of the high costs for cryogenic pipelines.

It is an object of the invention to minimize the above problem.

It is a further object of the present invention to provide an alternative method for liquefying a natural gas stream, in particular under very cold conditions such as those that are encountered in the Arctic region.

One or more of the above or other objects are achieved according to the present invention by providing a method of liquefying a natural gas stream, the method at least comprising the steps of:

(a) providing a natural gas stream at a first location;

(b) treating the natural gas stream in the first location thereby obtaining a treated natural gas stream, wherein the treated natural gas stream comprises in the range of from 70 to 100 mole % of methane;

(c) transporting the treated natural gas stream via a pipeline over a distance of at least 2 km to a second location;

(d) liquefying the treated natural gas stream (20) at the second location thereby obtaining liquefied hydrocarbon product at atmospheric pressure.

The first and the second location may be situated both onshore or off-shore. Thus, combinations of onshore-onshore, off-shore-off-shore, onshore-offshore and off-shore-onshore for the first and second location are all comprised in the invention.

An advantage of the invention is that less equipment is needed in both locations; this enables liquefying a natural gas stream even when limited plot space is available onshore and/or off-shore.

Another advantage is that, in particular if the method of the present invention is applied in very cold regions such as the Arctic, use can be made of the cold ambient whereby the treated natural gas stream can be cooled to a certain extent before the actual liquefaction takes place. This may result in a reduced CAPEX (capital expenses) for the liquefaction equipment.

In a preferred embodiment, the second location is situated off-shore. An advantage of this preferred embodiment is that the liquefied hydrocarbon product can be easily transported from the second location using a transportation vessel. Thus, no liquefied hydrocarbon product, in particular LNG, has to be transported over long distances via a pipeline.

The first and second locations are not limited to include only a single process or treating unit but are rather intended to include a plant site containing one or more process units. The first and second locations are at a distance of at least 2 km from each other, preferably at least 5 km, more preferably at least 10 km. The distance may be longer than 1000 km but is preferably less than 900 km.

The first location is preferably situated near a site where the natural gas stream to be treated and liquefied is produced, such as a natural gas or a petroleum reservoir. On the first location one or more treating units are located. These treating units may include conventional treating units such as a slug catcher, a condensate stabilizer, acid gas removal (AGR) units, dehydration units, sulphur recovery units (SRU), mercury removal units, nitrogen rejection units (NRU), helium recovery units (HRU), hydrocarbon dewpoint units, etc. Also fractionation or extraction units for recovery of e.g. C₃/C₄ liquid petroleum gas (LPG) and C₅₊ liquid (condensate) may be present on the first location. As these treating units as such are well known to the person skilled in the art, they are not further discussed here.

The second location is preferably situated near an LNG export terminal from where the liquefied natural gas is shipped or otherwise transported to the desired markets. On the second location at least a liquefaction plant is present to obtain a liquefied hydrocarbon product. If desired, also some of the treating units mentioned in respect of the first location may be present at the second location. However, preferably as few treating units as possible are located at the second location. Herewith the amount of handling (and thereby the presence of workpeople) near the liquefaction plant can be minimized. Furthermore, the plot space on the second location is minimised.

The natural gas stream may be any suitable natural gas stream to be treated and liquefied, but is usually a natural gas stream produced at and obtained from natural gas or petroleum reservoirs. As an alternative the natural gas stream may also be obtained from another source, also including a synthetic source such as a Fischer-Tropsch process wherein methane is produced from synthesis gas.

Usually the natural gas is comprised substantially of methane. Preferably the feed stream comprises at least 60 mol % methane, more preferably at least 80 mol % methane.

Depending on the source, the natural gas may contain varying amounts of hydrocarbons heavier than methane such as ethane, propane, butanes and pentanes as well as some aromatic hydrocarbons. The natural gas may also contain non-hydrocarbons such as H₂O, N₂, CO₂, H₂S and other sulphur compounds, and the like.

According to preferred embodiment, the treating in step (b) at least comprises removal of CO₂, preferably such that the treated natural gas stream comprises less than 500 ppm CO₂, more preferably less than 200 ppm CO₂, even more preferably less than 50 ppm CO₂. It is especially preferred that no CO₂ removal takes place at the second location.

Further it is preferred that the treating in step (b) at least comprises removal of H₂O, preferably such that the treated natural gas stream comprises less than 100 ppm H₂O, more preferably less than 10 ppm H₂O, even more preferably less than 1 ppm H₂O.

In addition it is preferred that the treating in step (b) comprises removal of mercury (Hg).

The treated natural gas stream to be liquefied comprises in the range of from 70 to 100 mole % of methane, preferably from 80 to 100 mole % of methane. Preferably, the treated natural gas stream to be liquefied comprises less than 5 mole %, preferably less than 1 mole % of C₅+ hydrocarbons, meaning pentanes and heavier hydrocarbons.

Preferably the treated natural gas stream is compressed before transporting in step (c), preferably to a pressure above 50 bar, more preferably above 60 bar, still more preferably above 70 bar. It is especially preferred that the treated natural gas stream is transported in a state being substantially above the critical point. In this way, the treated natural gas stream can be transported in substantially a dense phase.

According to an especially preferred embodiment of the present invention, the treated natural gas stream is cooled during transporting by heat exchanging against the ambient. Preferably, the treated natural gas stream is cooled to a temperature <10° C., preferably <0° C., more preferably <−10° C. before it reaches the second location. Herewith the cooling duty in the liquefaction plant at the second location can be significantly decreased. It is desirable that the distance between the first and second location is such that the treated natural gas stream is cooled as much as possible, preferably reaching ambient temperatures, if it is transported via a pipeline that is substantially not thermally insulated. Herewith, full advantage of cold ambient conditions may be used, in particular if the pipeline is in a cold area such as in Arctic regions. It is believed that this can be achieved when the distance between the first and second location is more than 2 km, preferably more than 5 km, still more preferably more than 10 km.

In step (d) the treated natural gas stream is liquefied. Suitably, this is done using one or more refrigerants. The refrigerants may be produced in the second location or may be produced elsewhere and transported to the second location. Preferably, the refrigerants needed for liquefying the treated natural gas stream are produced in a location that is geographically removed from the second location where liquefaction takes place. Preferably the distance between the location where the refrigerants are produced and the second location is more than 2 km, more preferably more than 5 km.

In one preferred embodiment, a mixed refrigerant comprising at least two refrigerants is used and the refrigerants are transported to the second location via separate pipelines for each of the pure component refrigerants that make up the mixed refrigerant as used in the liquefaction process. This solution offers the simplest line-up operation-wise for the supply and make-up of the required refrigerants.

In another embodiment, a mixed refrigerant comprising at least two refrigerants is used and the different pure component refrigerants are delivered pre-mixed via a common pipeline. The advantage of this embodiment is the elimination of the other pipelines that would otherwise be required to transport the different refrigerant components separately.

In yet another embodiment, a mixed refrigerant comprising at least two refrigerants is used and the different pure refrigerant components are delivered to the second location via a single pipeline in successive plug-flows. The advantage is that there is no need for a fractionation column at the second location to separate the mixed refrigerants.

In another embodiment, refrigerant is supplied to the second location via pipelines and the refrigerant supply pipelines are used as storage vessels to eliminate (or reduce) storage of the refrigerants at the second location. This further reduces the plot space needed at the second location.

The refrigerant is used to cool down the treated natural gas stream to less than −140° C., preferably less than −150°C. The cooling step is followed by expansion to atmospheric pressure. The liquefied hydrocarbon product is obtained at atmospheric pressure.

After liquefaction the liquefied hydrocarbon product is usually transported and regasified. The transportation of the liquefied hydrocarbon product such as LNG is usually performed by shipping. Regasification is usually done at e.g. an LNG import terminal that may be onshore or offshore.

The person skilled in the art will readily understand that after liquefaction, the liquefied hydrocarbon product may be further processed before transporting, if desired.

In a further aspect the present invention provides an apparatus for liquefying a natural gas stream, the apparatus at least comprising:

one or more treating units at a first location for obtaining a treated natural gas stream;

at least one liquefaction plant at a second location for producing a liquefied hydrocarbon product at atmospheric pressure;

a pipeline for transporting the treated natural gas stream to the second location over a distance of at least 2 km. The first and the second location may be situated both on-shore or off-shore. Thus, combinations of on-shore-onshore, off-shore-off-shore, on-shore-off-shore and on-shore-off-shore for the first and second location respectively are all comprised in the invention. In a preferred embodiment, the first location is situated on-shore and the second location is situated off-shore.

Preferably one of the treating units at the first location is adapted for removal of CO₂. Further it is preferred that no CO₂ removal from the treated natural gas stream takes place at the second location. Also it is preferred that one of the treating units at the first location is adapted for removal of H₂O.

Usually the apparatus according to the present invention further comprises a compressor for compressing the treated natural gas stream at the first location, preferably to a pressure above 50 bar, preferably above 60 bar, more preferably above 70 bar.

According to an especially preferred embodiment the pipeline is substantially not thermally insulated. This enables cooling of the treated natural gas stream against the ambient during transport from the first to the second location. If the transport takes place in a cold environment such as the Arctic region, use of the cold ambient can be made.

Hereinafter the invention will be further illustrated by the following non-limiting drawing. Herein shows:

FIG. 1 schematically a process scheme in accordance with the present invention; and

FIG. 2 schematically a process scheme in accordance with another embodiment of the present invention.

For the purpose of this description, a single reference number will be assigned to a line as well as a stream carried in that line. Same reference numbers refer to similar components.

FIG. 1 schematically shows a process scheme (generally indicated with reference No. 1) for the treating and liquefaction of a natural gas stream such as natural gas.

The process scheme of FIG. 1 is divided over two separate locations, viz. a first location 2 and a second location 3. The first location 2 is usually situated near a site where the natural gas to be treated and liquefied is produced, such as a natural gas or a petroleum reservoir (not shown). Preferably the first location is onshore. On the first location 2 one or more treating units are located. These treating units may include conventional treating units such as a slug catcher; a condensate stabilizer; acid gas removal (AGR) units for removal of CO₂, H₂S and other sour gases; dehydration units for the removal of H₂O; sulphur recovery units (SRU); mercury removal units; nitrogen rejection units (NRU); helium recovery units (HRU); hydrocarbon dewpoint units; etc. Also fractionation or extraction units for recovery of e.g. C₃/C₄ liquid petroleum gas (LPG) and C₅₊ liquid (condensate) may be present at the first location 2. As these treating units as such are well known to the person skilled in the art, they are not further discussed here.

In the embodiment of FIG. 1, the first location 2 contains a CO₂ removal unit 11, a dehydration unit 12, a mercury removal unit 13, and a hydrocarbon dew-pointing facility 14 for removing selected heavier hydrocarbons from the natural gas. Furthermore, two coolers 15,16 as well as a compressor 17 are present. If desired, the compressor 17 may be a train of two or more compressors.

The second location 3 is preferably situated near an LNG export terminal from where the produced liquefied natural gas is shipped or otherwise transported to the desired markets. The distance between the second location and the first location is at least 2 km, and may be as high as 900 km. On the second location 3 at least a liquefaction plant 21 is present to obtain LNG.

If desired, also some of the treating units mentioned in respect of the first location 2 may be present at the second location 3. In the embodiment of FIG. 1, the second location 3 includes a liquefaction plant 21 (that may have various line-ups as is known in the art), and upstream of the liquefaction plant, a scrub column 18 in which C₃₊ hydrocarbons are removed from the natural gas and sent to a fractionation unit 19 for further workup. Furthermore some coolers 22, 23 and 24 are present During use of the process scheme shown in FIG. 1, a feed stream 10 (as e.g. obtained from the natural gas or petroleum reservoir) is processed by the various treatment units at the first location 2 thereby obtaining a treated natural gas stream 20. Typically, the inlet pressure of the feed stream 10 will be between 50 and 100 bar and the temperature will usually between 0 and 60° C. After treating of the stream 10 a treated natural gas stream 20 is obtained. Dependent on the treating steps performed, the treated natural gas stream 20 usually will have a temperature in the range of about 40-90° C., typically about 80° C.

Stream 20 is subsequently transported via pipeline 4 to the second location 3. The pipeline may be above or under the ground, or surrounded by sea water. In particular if the pipeline 4 is in a cold area, such as the Arctic region, it is preferred that the pipeline 4 is substantially not thermally insulated from the ambient such that the treated stream 20 is cooled against the ambient. To this end, the pipeline 4 may be substantially made from low temperature resistant carbon steel. Preferably, the treated stream 20 is cooled during transport in the pipeline 4 to a temperature <10° C., preferably <0° C., more preferably <−10° C. before it reaches the second location 3. Of course, the amount of cooling in the pipeline will depend on various factors such as the ambient temperature, the length of the pipeline 4 and the materials used in the pipeline 4. It has been found that suitable results may be obtained if the pipeline 4 is at least 2 km long.

In the embodiment of FIG. 1, the treated stream 20 is further treated at the second location 3 to remove C₃₊ hydrocarbons (which are sent to the fractionation unit 19 as stream 60). The resulting leaner stream 40 is (after cooling in cooler 23) passed to the liquefaction plant 21 in which a LNG product 50 is produced. The LNG 50 may be sent to an LNG export terminal for transportation to remote markets in which the LNG will be regasified again on or near a LNG import terminal (not shown). The regasification of the LNG may take place onshore or offshore. Thereafter the regasified gas may be sent to a gas network and distributed to the end users.

The (one or more) product(s) obtained may be used as fuel or refrigerant. If desired, at least a part of the product 70 may be sent back to the first location 2.

FIG. 2 shows an alternative embodiment of the present invention, in which also the scrub column 18 and fractionation unit 19 are placed at the first location 2. In this embodiment the treated stream 20 is already suitable for liquefaction before it is passed via the pipeline 4 to the second location 3. Thus, no treatment needs to be performed at the second location 3.

The person skilled in the art will readily understand that many modifications may be made without departing from the scope of the invention.

1. A method of liquefying natural gas, the method at least comprising the steps of:
(a) providing a natural gas stream at a first location, the first location being situated off-shore;
(b) treating the natural gas stream in the first location thereby obtaining a treated natural gas stream, wherein the treated natural gas stream comprises in the range of from 70 to 100 mole % of methane;
(c) transporting the treated natural gas stream via a pipeline over a distance of at least 2 km to a second location, the second location being situated off-shore and near an LNG export terminal;
(d) liquefying the treated natural gas stream at the second location thereby obtaining liquefied hydrocarbon product at atmospheric pressure; and
(e) sending the liquefied hydrocarbon product to the LNG export terminal for transportation to a market.

2. Method according to claim 1, wherein the treating in step (b) at least comprises removal of CO₂.

3. The method according to claim 2, wherein no CO₂ removal takes place at the second location.

4. The method according to claim 1 wherein the treating in step (b) at least comprises removal of H₂O.

5. The method according to claim 1, wherein the treated natural gas stream is compressed before transporting in step (c).

6. The method according to claim 1, wherein the treated natural gas stream is transported in a state being substantially above the critical point.

7. The method according to claim 1, wherein during transporting the treated natural gas stream is cooled by heat exchanging against the ambient.

8. The method according to claim 7, wherein the treated natural gas stream is cooled to a temperature <10° C., before it reaches the second location.

9. The method according to claim 1, wherein the treated natural gas stream comprises less than 5 mol %, C₅+ hydrocarbons.

10. The method according to claim 1, wherein the liquefied hydrocarbon product is transported and regasified.

11. The method according to claim 1, wherein in step (d) a refrigerant is used, which refrigerant is produced at a different location than the second location and supplied to the second location via a pipeline.

12. An apparatus for liquefying a natural gas stream, the apparatus at least comprising:
one or more treating units at a first location for obtaining a treated natural gas stream, the first location being situated off-shore;
at least one liquefaction plant at a second location for producing a liquefied hydrocarbon product at atmospheric pressure, the second location being situated off-shore and near an LNG export terminal;
a pipeline for transporting the treated natural gas stream to the second location over a distance of at least 2 km.

13. The apparatus according to claim 12, wherein one of the treating units at the first location is adapted for the removal of CO₂.

14. The apparatus according to claim 12, wherein no CO₂ removal from the treated natural gas stream takes place at the second location.

15. The apparatus according to claim 12, wherein one of the treating units at the first location is adapted for the removal of H₂O.

16. The apparatus according to claim 11, the apparatus further comprising a compressor for compressing the treated natural gas stream at the first location.

17. The apparatus according to claim 12, wherein the pipeline is substantially not thermally insulated.

18. The method according to claim 1, wherein the treating in step (b) at least comprises removal of CO₂ such that the treated natural gas stream comprises less then 500 ppm CO₂.

19. The method according to claim 1, wherein the treating in step (b) at least comprises removal of H₂O such that the treated natural gas stream comprises less than 100 ppm H₂O.

20. The method according to claim 1, wherein the treated natural gas stream is compressed before transporting in step (c) to a pressure above 50 bar.
